(19) United States
(12) Patent Application Publication
(10) Pub. No.: US 2009/0316269 A1
(43) Pub. Date: Dec. 24, 2009

(54) OPTICAL SHEETS

(75) Inventors: Hyun Jin Kim, Gyeonggi-do (KR); Jong Min Park, Gyeonggi-do (KR)

Correspondence Address: SUGHRUE MION, PLLC, 2100 PENNSYLVANIA AVENUE, N.W., SUITE 800, WASHINGTON, DC, 20037, US

(73) Assignee: KOLON INDUSTRIES, INC., Gwacheon-si (KR)

(21) Appl. No.: 12/519,686

(22) PCT Filed: Dec. 18, 2007
(86) PCT No.: PCT/KR07/06630

§ 371 Date: Jun. 17, 2009

(30) Foreign Application Priority Data
Dec. 18, 2006 (KR) 10-2006-0129215

(51) Int. Cl. G02B 5/02

(52) U.S. Cl. 359/599

(57) ABSTRACT

Disclosed is an optical film having an optical structure, such as a prism film or sheet, which is a constituent of a backlight unit. The optical film includes an optical structure layer having a plurality of optical structures, the surface of which is formed with irregularities, and the irregularities are formed on the surface of the light-collecting optical structure to satisfy predetermined conditions, thus effectively realizing a light-diffusing function, thereby eliminating the need to additionally mount a diffusion film or a protection film. When a particle dispersion layer is further formed on the surface of a transparent substrate opposite the surface having the optical structure layer, damage due to friction to prism films or other sheets may be prevented during the layering of the prism films or transport, thus obviating the use of a plurality of optical films.

### TECHNICAL FIELD

The present invention relates to an optical sheet, which is used for liquid crystal displays (LCDs), such as monitors, PDAs (Personal Digital Assistants), notebook computers, LCD TVs, computers, word processors, and mobile phones, in order to increase brightness.

### BACKGROUND ART

With the development of the present industrial society toward an advanced information age, the importance of electronic displays as a medium for transferring various pieces of information is increasing day by day. Accordingly, industries related to various types of flat displays, including LCDs, PDPs, and organic ELs, are prospering. In particular, an LCD, which plays a leading role in the growth of the flat display industry, is a technologically intensive product resulting from the combination of liquid crystal-semiconductor techniques, and is advantageous because it is thinner and lighter and has lower consumption power compared to other kinds of displays. Thus, the LCD may be applied not only to notebook computers, monitors, and small appliances (PDAs and mobile phones), but also to TVs, which have been regarded as the exclusive field of CRTs, which are conventional Braun tube type displays, whereby it is receiving attention as a novel display able to substitute for Braun Tube type displays, which have become a synonym for displays.

Because the liquid crystals of the LCD do not function to directly emit light, an additional light source is provided at the back surface thereof so as to display light emitted through the liquid crystals. Such a light-emitting device is called a backlight unit (BLU), which is typically composed of a cold cathode fluorescent lamp (CCFL), serving as a light source, and assistant means, including a light guide plate (LGP), a light diffusion plate, and a prism sheet, which are sequentially arranged from the light source. The light guide plate functions to actually convert an irregular linear light source, emitted from the CCFL, to the front. The light diffusion film or sheet functions to diffuse light guided to the front into surface light, and light thus diffused is collected in a direction perpendicular to the screen by the prism film or sheet, thereby increasing the front brightness of the screen, resulting in a brighter and clear image.

That is, light that is radially emitted from the lamp but may be lost is guided to the front of the screen using the light guide plate, and furthermore, light that is lost to the back surface of the screen may be re-used using a reflection film or sheet (hereinafter, referred to as a “reflection plate”). However, the light guided to the front through the reflection plate and the light guide plate has non-uniform brightness over the entire surface, and thus, it is guided to form uniform surface light using the light diffusion film or sheet. Further, the light passed through the light diffusion film or sheet is diffused again, and thus, the brightness of the front of the display is decreased. Hence, the case where an image is seen in a direction perpendicular to the screen of the display results in decreased front brightness. Accordingly, with the goal of increasing the front brightness, light transmittance to the front of the screen is increased. To this end, a film or sheet using a prism structure disclosed in U.S. Pat. Nos. 2,248,638 and 4,497,860 is applied, thereby increasing the front brightness. It has been verified that, when the film having a prism structure is used in twos such that two films are orthogonally arranged or are oriented at a predetermined angle, front-surface light-collecting efficiency is increased (U.S. Pat. No. 4,542,449) compared to when used individually. At present, one film having a prism structure may be used, or alternatively, two films having a prism structure may be used in a state of being orthogonally arranged.

This film is manufactured by forming a roll or large-area sheet having a prism structure using transparent curable resin on a transparent film of polyester or polycarbonate, after which the sheet thus formed is cut to the size and shape required for mounting to an actual device, and then one film thus cut may be mounted to the backlight unit frame of an LCD, or two films may be orthogonally arranged and mounted thereto.

Moreover, a light diffusion film is mounted under the prism film to uniformly diffused light directed upward through the light guide plate or the light diffusion plate, and a light-diffusing protection film is mounted on the prism film to prevent damage to the ridges of the prisms due to friction and damage to a lower polarizer film of a liquid crystal module, which is to be positioned on the backlight unit.

However, the device thus manufactured suffers because three different types of optical films are used during the manufacturing process, undesirably increasing costs and decreasing efficiency. Further, in the process of assembling the optical films of the backlight unit, the protection film and the prism film may be defective, undesirably decreasing overall material efficiency.

### DISCLOSURE

### Technical Problem

Accordingly, the present invention provides an optical sheet, in which the surface of a light-collecting optical structure is formed with irregularities, and thus the light-collecting efficiency of an optical film is maintained, and simultaneously, the diffusion of light is induced, thereby realizing the function of a diffusion film.

In addition, the present invention provides an optical sheet, in which the surface of the light-collecting optical structure of a light-collecting optical film, such as a prism film, is formed with irregularities, thereby obviating the use of a protection film for protecting the optical film.

In addition, the present invention provides an optical sheet, which includes a particle dispersion layer having protruding particles on the surface opposite the surface having an optical structure layer, and thus the contact area between the layered devices or between the layered prism films in the course of assembling the prism films is decreased by the protruding particles, thereby decreasing damage to the surface of the non-structural layer during separation into respective films or transport.

In addition, the present invention provides an optical sheet, which includes a particle dispersion layer having protruding particles on the surface opposite the surface having an optical structure layer, and thus, when a plurality of prism films is orthogonally arranged and layered in a backlight unit, the ridges of the prisms are brought into contact with the protruding particles, thereby decreasing the contact area between the prism films and inducing a cushioning function of the particles, consequently decreasing damage to the ridges of the prism films and damage to the surface of the non-structural layer.

In addition, the present invention provides an optical sheet, which includes a particle dispersion layer having protruding particles and containing an antistatic agent on the surface opposite the surface having an optical structure layer, thus eliminating the generation of static electricity due to friction, thereby preventing image quality from deteriorating due to the attachment of impurities.

### Technical Solution

According to a first embodiment of the present invention, there is provided an optical sheet, comprising a transparent substrate and an optical structure layer having a plurality of optical structures formed using a curable resin composition on a surface of the transparent substrate, wherein a surface of the plurality of optical structures may be formed with irregularities such that the arithmetical average roughness (Sa) is 0.01 or more and the ten point median height (Sz) is 0.1 or more.

In the optical sheet according to the first embodiment of the present invention, the plurality of optical structures may be a triangular prism structure, a trigonal pyramidal structure, a conical structure, a spherical structure, or a non-spherical structure.

In the optical sheet according to the preferred embodiment of the present invention, the plurality of optical structures may be a triangular prism structure.

According to a second embodiment of the present invention, the optical sheet may further comprise a particle dispersion layer comprising a transparent binder and particles, formed on a surface of the transparent substrate opposite the surface having the optical structure layer, the particles of the particle dispersion layer protruding from a surface thereof.

As such, the particles of the particle dispersion layer may protrude such that a height of protruding portions of the particles does not exceed 50% of a particle size.

The particle dispersion layer may further comprise an antistatic agent.

### ADVANTAGEOUS EFFECTS

In the optical sheet according to the present invention, the surface of a light-collecting optical structure, such as a prism, is formed with irregularities, thus realizing not only a light-collecting function but also a light-diffusing function. Thereby, there is no need to additionally mount a diffusion film, and also, the use of a protection film may be obviated. Further, a particle dispersion layer is formed on the surface of the optical sheet opposite the surface having a light-collecting optical structure layer including prisms, thereby preventing damage due to friction to the prism films or other sheets, ultimately obviating the use of a plurality of optical films. Thereby, it is possible to economically manufacture a backlight unit with improved productivity.

### DESCRIPTION OF DRAWINGS

FIG. 1 is a cross-sectional view illustrating an optical sheet according to a first embodiment of the present invention; and

FIG. 2 is a cross-sectional view illustrating an optical sheet according to a second embodiment of the present invention.

### DESCRIPTION OF THE REFERENCE NUMERALS IN THE DRAWINGS

100: transparent substrate
200: optical structure layer
210: optical structure
211: irregularities
300: particle dispersion layer
301: particles

### BEST MODE

Hereinafter, a detailed description will be given of the present invention.

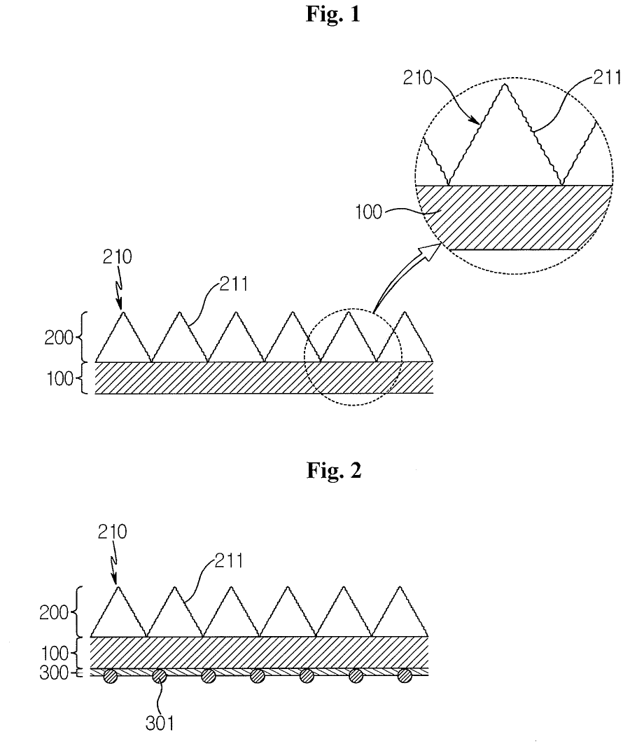

The present invention is directed to a prism film for use in a backlight unit of an LCD. A cross-sectional view thereof is illustrated in FIG. 1.

With reference to FIG. 1, the prism film of the present invention, that is, the film including an optical structure layer, has a construction in which irregularities 211 are formed on the surface of a plurality of optical structures 210 constituting the optical structure layer.

As specifically seen in the enlarged view of FIG. 1, the surface of a plurality of optical structures 210 constituting the optical structure layer is not smooth, but is rough.

In this way, when the surface of the optical structure is formed with irregularities, the light-collecting efficiency of the prism film is maintained, and simultaneously, the diffusion of light is induced through the rough surface of the optical structure. Thereby, a protection film, which is conventionally used to protect the prism film, may be omitted, resulting in decreased costs and increased efficiency. Further, because the surface of the optical structure is formed with irregularities, surface roughness is controlled, thereby exhibiting the function of a diffusion film, which is provided under the film having the optical structure layer.

When the surface of the optical structure of the optical structure layer is formed with irregularities, surface roughness is formed such that the arithmetical average roughness (Sa) is 0.01 or more and the ten point median height (Sz) is 0.1 or more. If the surface roughness is formed such that the arithmetical average roughness is less than 0.01 or the ten point median height is less than 0.1, the light-collecting effect may be maintained, but the diffusion effect, which is intended in the present invention, is difficult to realize. In the case where there is no diffusion effect, in order to protect the optical film having the optical structure layer, that is, the prism film, a protection film must be provided on the structural layer of the prism film, thus making it difficult to reduce the cost. In the case where the protection film is omitted and only an optical film having a structure without a diffusion function is used, the shape of such a structure may be projected as it is from the backlight unit, or light may leak from the mold portion of the edge of the backlight unit during the assembly process.

The process of forming the irregularities on the surface of the optical structure is not limited, but includes, for example, controlling the roughness of the surface of a roll for forming an optical structure or forming irregularities on the surface of a prism film having no irregularities using physical force.

The plurality of optical structures constituting the optical structural layer may be a typical triangular prism structure. In addition, useful is a trigonal pyramidal structure, a conical structure, a spherical structure, or a non-spherical structure. In particular, in the interest of the light-collecting efficiency to the front of the screen, it is preferred that the optical structure be a triangular prism structure.

For a transparent substrate 100 on which the optical structure layer is formed, any substrate may be used as long as it is transparent, and examples thereof include polycarbonate, polypropylene, polyethyleneterephthalate, polyethylene, polystyrene, and epoxy. Particularly useful is polycarbonate or polyethyleneterephthalate. Such a plastic substrate should have force of adhesion to the resin that is to be applied thereto, should have high light transmittance, so as not to affect the light diffusion layer, and should have uniform surface smoothness, so as not to exhibit brightness variation. The thickness of the plastic substrate ranges from 10 μm to 1000 μm, and preferably 25 μm to 500 μm.

On the transparent plastic substrate, the optical structures having surface irregularities are formed using a transparent curable resin having a higher refractive index than the plastic substrate, in order to increase the front brightness.

In the present invention, the optical film having the optical structure layer may further include a particle dispersion layer on the surface of the transparent substrate opposite the surface on which the optical structure layer is formed. A cross-sectional view thereof is illustrated in FIG. 2.

With reference to FIG. 2, the particle dispersion layer 300 is composed of a transparent organic binder and organic or inorganic particles 301. The particle dispersion layer is formed of resin, which has high adhesiveness to the plastic substrate and high compatibility with the particles, and specific examples of such resin include acrylic resins, including unsaturated polyester, methyl methacrylate, ethyl methacrylate, isobutyl methacrylate, n-butyl methacrylate, n-butyl methyl methacrylate, acrylic acid, methacrylic acid, hydroxyethyl methacrylate, hydroxypropyl methacrylate, hydroxyethyl acrylate, acrylamide, methylolacrylamide, glycidyl methacrylate, ethyl acrylate, isobutyl acrylate, n-butyl acrylate, and 2-ethylhexyl acrylate polymers, copolymers or terpolymers, urethane-based resins, epoxy-based resins, or melamine-based resins. In order to increase heat resistance, wear resistance, and adhesiveness, a curing agent may be used to thus solidify the film of the resin.

In the preparation of the particle dispersion layer, the particles are exemplified by various organic and inorganic particles. Specific examples of the organic particles include acrylic particles, including methyl methacrylate, acrylic acid, methacrylic acid, hydroxyethyl methacrylate, hydroxypropyl methacrylate, acrylamide, methylolacrylamide, glycidyl methacrylate, ethyl acrylate, isobutyl acrylate, n-butyl acrylate, and 2-ethylhexyl acrylate polymers, olefinic particles, including polyethylene, polystyrene, or polypropylene, and multilayer multicomponent particles obtained by forming particles of acryl-olefin copolymers or homopolymers and then covering them with another type of monomer. In addition, inorganic particles, including silicon oxide, aluminum oxide, titanium oxide, zirconium oxide, or magnesium fluoride, are exemplary.

The size of the particles used for the particle dispersion layer varies depending on the thickness of the coating film, but is preferably set to 0.1˜20 μm. If the particles have a large size, the protruding portion thereof is too high, and thus the ridge of the optical structure may be damaged. Preferably, the particles have a size of 0.1˜10 μm.

When the particle dispersion layer is formed, the particles are used in an amount of 0.1˜100 parts by weight, based on 100 parts by weight of the organic binder. If the amount of particles is large, in the case of organic particles, light may be diffused, or, in the case of inorganic particles, light may be reflected from the surface of the particles, undesirably decreasing light efficiency. Thus, the particles are preferably used in an amount of 1˜50 parts by weight.

In the case where portions of respective particles that protrude from the surface of the particle dispersion layer are proportionally relatively large, the ridges of the prisms may be damaged by the protruding particles. Thus, the particles should protrude such that the height of the protruding portions thereof does not exceed 50% of the particle diameter.

In addition to the particles, the particle dispersion layer may further include an antistatic agent for imparting contamination resistance to prevent the generation of dust or impurities during the manufacture of the backlight unit. The antistatic agent includes, for example, quaternary amine-, anion-, cation-, nonion-, or fluoride-based materials.

On one surface of the substrate film, formed of transparent plastic, the light-collecting structure formed of transparent curable resin is provided, and on the other surface thereof, the particle dispersion layer composed of a transparent organic binder and organic or inorganic particles is provided, thereby manufacturing an optical prism film resistant to damage from impacts, vibration, and handling.

When the film including the optical structure layer thus obtained is used for a backlight unit, the use of at least two films in a layered state is preferable.

In the case where the particle dispersion layer 300 is contained, when two optical films are layered, the protruding particles 301 of the particle dispersion layer 300 of the upper optical film are brought into contact with the optical structure layer 200 having surface irregularities of the lower optical film, and thus the contact area between the optical films is decreased, thereby preventing damage to the surface of the non-structural layer during separation into respective films or transport. Further, because the ridges of the optical structure layer are brought into contact with the protruding particles, the contact area between the optical films is decreased and the cushioning function of the particles is realized, thereby decreasing damage to the optical structure of the optical film and damage to the surface of the non-structural layer.

Furthermore, the irregularities 211 are formed on the surface of the optical structure 210, thereby realizing the diffusion function. Therefore, there is no need to additionally mount a diffusion film. Upon use of the films in a layered state or handling thereof, the particle dispersion layer 300 functions to prevent the optical structure or the surface of the film or sheet from being damaged due to impacts, vibration, and friction.

### MODE FOR INVENTION

A better understanding of the present invention may be obtained through the following examples, which are set forth to illustrate, but are not to be construed as the limit of the present invention.

### Example 1

90 parts by weight of acrylic polyol and 10 parts by weight of isocyanate were dissolved in 200 parts by weight of a methylethylketone solvent and 100 parts by weight of a toluene solvent, after which 50 parts by weight of PMMA particles (5 μm monodispersed particles) and 2 parts by weight of a quaternary amine-based antistatic agent were dispersed therein, thus preparing a solution for a particle dispersion layer.

The solution thus prepared was applied on one surface of a polyethyleneterephthalate (PET) substrate film (125 μm) using a gravure coater, and was then dried at 100° C. for 30 sec, thus manufacturing a film having a particle dispersion layer having a thickness of 6 μm, in which the thickness of the resin alone, having no particles, was 4 μm.

Thereafter, a mixture of 95 parts by weight of a UV curable acrylic resin and 5 parts by weight of a photoinitiator was applied on the other surface of the PET substrate film, and was then exposed to UV light, thus forming an optical structure layer including prism-shaped optical structures, having ridge angles of 90°, prism intervals of 50 μm, and heights of 25 μm, and also having surface roughness in which the arithmetical average roughness (Sa) was 0.09 and the ten point median height (Sz) was 0.5, thereby completing an optical prism sheet.

The perspective view of the optical prism sheet thus obtained is shown in FIG. 1, and the cross-sectional view thereof is shown in FIG. 4.

### Example 2

An optical prism sheet was manufactured in the same manner as in Example 1, with the exception that the optical structure layer was formed to have Sa of 0.02 and Sz of 0.2.

### Example 3

An optical prism sheet was manufactured in the same manner as in Example 1, with the exception that the optical structure layer was formed to have optical structures having a conical shape.

### Example 4

An optical prism sheet was manufactured in the same manner as in Example 1, with the exception that the solution for a particle dispersion layer was applied on one surface of the PET substrate film (125 μm) using a gravure coater, and was then dried at 100° C. for 30 sec, thus manufacturing a film having a particle dispersion layer having a thickness of 5 μm, in which the thickness of the resin alone, having no particles, was 2 μm.

### Example 5

An optical prism sheet was manufactured in the same manner as in Example 1, with the exception that a solution for a particle dispersion layer, including particles having a particle size of 15 μm, was applied on one surface of the PET substrate film (125 μm) using a gravure coater, and was then dried at 100° C. for 30 sec, thus manufacturing a film having a particle dispersion layer having a thickness of 15 μm, in which the thickness of the resin alone, having no particles, was 8 μm.

### Example 6

An optical prism sheet was manufactured in the same manner as in Example 1, with the exception that a solution for a particle dispersion layer containing no antistatic agent was used.

### Example 7

An optical prism sheet was manufactured in the same manner as in Example 1, with the exception that the particle dispersion layer was not formed.

### Comparative Example 1

An optical prism sheet was manufactured in the same manner as in Example 1, with the exception that the particle dispersion layer was not formed, and a prism structure without surface irregularities was applied.

### Comparative Example 2

An optical prism sheet was manufactured in the same manner as in Example 1, with the exception that a prism structure without surface irregularities was applied.

### Comparative Example 3

A BEFII product, available from 3M, was used.

### Comparative Example 4

An optical prism sheet was manufactured in the same manner as in Example 1, with the exception that an optical structure layer was formed to have Sa of 0.007 and Sz of 0.05.

The optical films obtained in the examples and comparative examples were measured for surface roughness, haze, brightness, surface resistivity, and number of damaged ridges of prisms. The results are shown in Table 2 below. The measurement methods thereof were as follows.

(1) Measurement of Surface Roughness: The surface of the optical structure was measured using an LSM 5 Pascal product, available from Carl Zeiss, and the measurement thereof is described in detail in Table 1 below.

(2) Measurement of Total Transmittance and Haze

The haze values were compared using a haze meter, NDH2000, available from Nippon Denshoku. According to the equation of ‘haze (%)=light diffusivity/total light transmittance×100’, light diffusivity was evaluated.

(3) Brightness

On a 17 inch LM170E01 (Heesung Electronics, Korea) Model, from which ready-made prism sheets were removed, the optical sheet, manufactured as above, was placed as below, after which 13-point brightness values thereof were measured and averaged using a brightness meter, BM7 (Topcon, Japan). The optical sheet was constructed in a manner such that two respective sheets of Examples 1 to 6 were orthogonally arranged and layered, and a light guide plate was placed thereunder. (light guide plate+sheet of the example+sheet of the example).

In Comparative Examples 1 to 4, the optical sheet was composed of a light guide plate, a diffusion film, the sheet of the comparative example, and a protection film, which were sequentially layered.

(4) Surface Resistivity

The resistivity was measured using a surface resistivity meter, Keithley 238 (Keithley).

(5) Damage of Ridge of Prism

Two prism sheets were orthogonally arranged and layered, and predetermined impact was applied thereto using a vibration tester, after which the number of damaged prisms per predetermined area of 1 cm×1 cm was counted using an electron scanning microscope.

TABLE 2

| | Surface | | | | Surface | No. of Damaged |
|---|---|---|---|---|---|---|
| | Roughness | | | Brightness | Resistivity | Prism Ridges |
| | Sa | Sz | Haze (%) | (cd/m²) | (Ω/□) | (No./cm²) |
| Criteria | — | — | — | — | 10¹² or less | No Damage |
| Ex. 1 | 0.09 | 0.5 | 50 | 2,055 | 10¹¹ | No |
| Ex. 2 | 0.02 | 0.2 | 30 | 2,100 | 10¹¹ | No |
| Ex. 3 | 0.09 | 0.5 | 50 | 2,070 | 10¹¹ | No |
| Ex. 4 | 0.09 | 0.5 | 50 | 2,053 | 10¹¹ | 5 |
| Ex. 5 | 0.09 | 0.5 | 50 | 2,051 | 10¹¹ | No |
| Ex. 6 | 0.09 | 0.5 | 50 | 2,052 | 10¹⁵ | No |
| Ex. 7 | 0.09 | 0.5 | 50 | 2,055 | 10¹⁵ | 4 |
| C. Ex. 1 | 0.001 | 0.005 | 15 | 2,045 | 10¹⁵ | 8 |
| C. Ex. 2 | 0.001 | 0.005 | 15 | 2,040 | 10¹¹ | No |
| C. Ex. 3 | 0.001 | 0.005 | 13 | 1,977 | 10¹⁵ | 7 |
| C. Ex. 4 | 0.007 | 0.05 | 20 | 2,035 | 10¹¹ | No |

As is apparent from the results of Table 2, in the case of the films having the optical structure layer manufactured in the examples, the surface of the optical structure of the optical structure layer could be seen to be formed with irregularities in the surface roughness ranges of Sa of 0.02˜0.09 and Sz of 0.2˜0.5. The haze thereof, as an index for evaluating light diffusivity, was improved. In the brightness test, when two films were layered without the diffusion film and the protection film, high brightness resulted. In the case where the particle dispersion layer (Examples 1 to 6) was provided, the attachment of impurities due to static electricity and scratching due to friction with external material were inhibited upon handling, thus decreasing or preventing damage to the film, compared to the case where the particle dispersion layer was not provided (Example 7). Further, the case where the antistatic agent was contained in the particle dispersion layer (Examples 1 to 5) had satisfactory surface resistivity and showed no damage to the ridges of the prisms when two prism films were layered. However, in the case where the irregularities were not formed on the surface of the prism structure and the particle dispersion layer was not provided (Comparative Examples 1 and 3), the ability to diffused light was not exhibited. From the point of view of compensation therefor, the diffusion film was additionally layered, but the brightness was lower than in the examples. Furthermore, the ridges of the prisms were damaged. In the case where the particle dispersion layer was provided but the irregularities were not formed on the surface of the prism structure (Comparative Example 2), the prism film itself had no diffusion effect. Thus, when only the prism film was used, only the contour line of the prism shape was seen. In order to prevent the projection of such a contour line and damage to the surface of the prism, it was necessary to use the protection film.

1. An optical sheet, comprising a transparent substrate and an optical structure layer having a plurality of optical structures formed using a curable resin composition on a surface of the transparent substrate, wherein a surface of the plurality of optical structures is formed with irregularities such that an arithmetical average roughness (Sa) is 0.01 or more and a ten point median height (Sz) is 0.1 or more.

2. The optical sheet according to claim 1, wherein the plurality of optical structures is a triangular prism structure, a trigonal pyramidal structure, a conical structure, a spherical structure, or a non-spherical structure.

3. The optical sheet according to claim 1, wherein the plurality of optical structures is a triangular prism structure.

4. The optical sheet according to claim 1, wherein a particle dispersion layer comprising a transparent binder and particles is formed on a surface of the transparent substrate opposite the surface having the optical structure layer, the particles of the particle dispersion layer protruding from a surface thereof.

5. The optical sheet according to claim 4, wherein the particles of the particle dispersion layer protrude such that a height of protruding portions of the particles does not exceed 50% of a particle size.

6. The optical sheet according to claim 4, wherein the particle dispersion layer further comprises an antistatic agent.

7. The optical sheet according to claim 2, wherein the plurality of optical structures is a triangular prism structure.
